(19) United States
(12) Patent Application Publication
(10) Pub. No.: US 2009/0046327 A1
(43) Pub. Date: Feb. 19, 2009

(54) Image Processing Device

(75) Inventor: Toshifumi SAKAI, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/189,306

(22) Filed: Aug. 11, 2008

(30) Foreign Application Priority Data
Aug. 17, 2007 (JP) 2007-212647

(51) Int. Cl. H04N 1/40

(52) U.S. Cl. 358/471

(57) ABSTRACT

An image processing device, which processes an image, includes a first key, a second key, a parameter setting unit which selects a processing object image on the basis of manipulation of the first key from a plurality of images of image data recorded in different formats and belonging to a single group and which sets processing parameters on the basis of manipulation of the second key for the selected processing object image, and a processing unit which processes the plurality of images of the image data according to the processing parameters set with respect to each of the plurality of images of the image data.

### BACKGROUND

1. Technical Field

The present invention relates to an image processing device which processes an image.

2. Related Art

JP-A-2005-99472 discloses a known image processing device including a cross-shaped key button and changing image data displayed on a display unit by manipulation of the cross-shaped key button. The device can selects an image to be printed by changing a previous image to a next image by manipulation of left and right directions of the cross-shaped key button. A selected image undergoes a printing process when a print setting such as paper type or paper size is performed and starting of printing is instructed using a manipulation panel.

In addition, a digital camera having a function of simultaneously recording an RAW file which is a file of an undeveloped photographic image and a JPEG file which is a file produced by developing the photographic image and compressing the developed image in JPEG format is disclosed. When trying to print an image group containing the simultaneously recorded JPEG data and RAW data in a lump using a printer, it is desirable that a print setting can be performed for each of the images belonging to one image group. However, it was generally difficult to perform such setting by simple manipulation because of constraints attributable to a manipulation system arranged in the printer. This problem is not only for the printer but commonly arises in all devices such as digital cameras and viewers having constrains in manipulation systems when setting processing parameters with respect to images of an image group including the simultaneously recorded JPEG and RAW data, separately.

### SUMMARY

An advantage of some aspects of the invention is that it provides an image processing device which allows a user to set processing parameters for each of a plurality of image data which belongs to a single group and is recorded in different formats by simplified manipulation.

In order to accomplish the advantage of some aspects of the invention, according to one aspect of the invention, there is provided an image processing device including a first key, a second key, a parameter setting unit which selects a processing object image from a plurality of image data recorded in different formats and belonging to a single group on the basis of manipulation of the first key and which sets processing parameters for the selected processing object image on the basis of manipulation of the second key, and a processing unit which processes the plurality of image data according to the processing parameters set with respect to each of the plurality of image data.

In the image processing device, as the image processing device has the first key and the second key, a single image is selected from the plurality of image data belonging to the same group and recorded in different formats on the basis of manipulation of the first key, processing parameters are set for the selected processing object image on the basis of manipulation of the second key, and the plurality of image data is processed with the set processing parameters, separately. Accordingly, it is possible to set processing parameters with respect to each of the plurality of images belonging to the same group and recorded in different formats by simple manipulation using the first and second keys.

In the image processing device, it is preferable that the plurality of image data belonging to the same group includes RAW data and JPEG data produced on the basis of the RAW data. With this structure, it is possible to set the processing parameters with respect to the JPEG data produced on the basis of the RAW data by simple manipulation in the unit of an image.

In the image processing device, it is preferable that the image processing device is connected to a printing device, the second key includes a pair of keys, the parameter setting unit is a unit for setting the number of print copies by incrementing or decrementing the number as the processing parameter by manipulation of the second key, and the processing unit is a unit for performing printing of the plurality of image data in the printing device according to the number of print copies which is set for each of the plurality of image data. With this structure, it is possible to set the number of print copies for each of the image data belonging to the same group and recorded in different formats by relatively simple manipulation.

It is preferable that the image processing device further includes a displaying portion which displays the plurality of image data belonging to the same group on a single screen and displays a manipulation screen for manipulating the first and second keys. With this structure, it is possible to check the plurality of image data belong to the same group at a singe time. Accordingly, it becomes easy to set the processing parameters with respect to each of the plurality of image data. In the image processing device, it is preferable that the parameter setting unit performs a pre-step for selecting one group containing the processing object image from a plurality of groups and the display control unit is a unit for displaying different screen in the pre-step and a step for selecting the processing object image from the plurality of image data belonging to the selected group.

It is preferable that the image processing device includes four-directional keys arranged in four directions (up, down, left, and right), in which the first key may be up and down keys or left and right keys, and the second key may be the other keys of the up and down keys and the left and right keys. With this structure, it is possible to perform the setting of the processing parameters by more perceptive manipulation.

In the image processing device, it is preferable that the parameter setting unit performs the pre-step for selecting one group containing the processing object image from a plurality of groups on the basis of manipulation of the first key or the second key. With this structure, since a plurality of functions is performed by manipulation of the first key and the second key, it is possible to realize a simplified manipulation system.

In the image processing device, it is preferable that manipulations of the first key and the second key are performed without intervention of any other keys between the manipulations of the first and second keys. With this structure, it is possible to simplify manipulations when setting the processing parameters with respect to each of the plurality of image data belonging to the same group.

### BRIEF DESCRIPTION OF THE DRAWINGS

The invention will be described with reference to the accompanying drawings, wherein like numbers reference like elements.

FIG. 1 is a block diagram illustrating the structure of a multifunction printer 10.

FIG. 2 is an explanatory view illustrating an example of an image file stored in a memory cart 42.

FIG. 3 is a flowchart illustrating an example of a printing processing routine.

FIG. 4 is an explanatory view illustrating an image selection screen 70.

FIG. 5 is an explanatory view illustrating an image display screen 80 which shows selected images.

FIG. 6 is a flowchart illustrating an example of a print copy-number setting routine.

### DESCRIPTION OF EXEMPLARY EMBODIMENTS

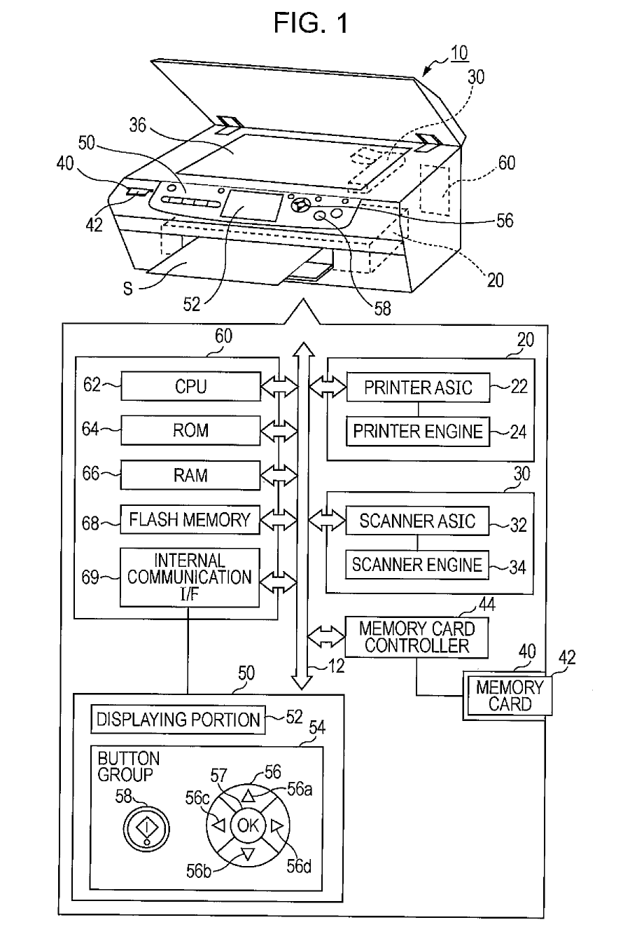

Hereinafter, embodiments of the invention will be described with reference to the accompanying drawings. FIG. 1 is a block diagram illustrating the overall structure of a multifunction printer 10 according to one embodiment of the invention.

As shown in FIG. 1, the multifunction printer 10 according to the embodiment of the invention includes a printer unit 20 which performs printing to print paper S on the basis of printing job, a scanner unit 30 which reads a document disposed on a glass substrate 36, a memory card controller 44 which controls input and output of data into and from a memory card 42 inserted into a memory cart slot 40, a manipulation panel 50 which displays various kinds of information at a displaying portion 52 or receives input of instruction by a user through manipulation of a button group 54, and a main controller 60 which controls the whole device. The multifunction printer 10 performs exchange of controls signals and data between the printer unit 20, the scanner unit 30, the memory card controller 44, and the main controller 60 via a bus 12.

The printer unit 20 includes a printer ASIC 22 and a printer engine 24. The printer ASIC 22 is an integrated circuit which controls the printer engine 24 and controls the printer engine 24 so as to print data on print paper S on the basis of an image file which is a printing object of a printing instruction when receiving a printing instruction from the main controller 60. The printer engine 24 is constituted as a known ink-jet type color printer which performs printing by discharging ink to print paper from a head. The ASIC stands for Application Specific Integrated Circuit.

The scanner unit 30 includes a scanner ASIC 32 and a scanner engine 34. The scanner ASIC 32 is an integrated circuit which controls the scanner engine 34 and controls the scanner engine 34 so as to read a document disposed on the glass substrate 36 as image data when receiving a scanning instruction from the main controller 60. The scanner engine 34 is constituted as a known image scanner and includes a known color image sensor which splits reflected light, which is light emitted toward the document and reflected from the document, into red R, green G, and blue B colors and produces scan data.

The memory card controller 44 performs data input and output into and from the memory card 42 inserted into the memory card slot 40 disposed next to the manipulation panel 50. The memory card controller 44 reads a file stored in the memory card 42 and sends the file to the main controller 60, or receives an instruction from the main controller 60 and writes data into the memory card 42 on the basis of the inputted instruction when the memory card 42 is connected to the memory card slot 40.

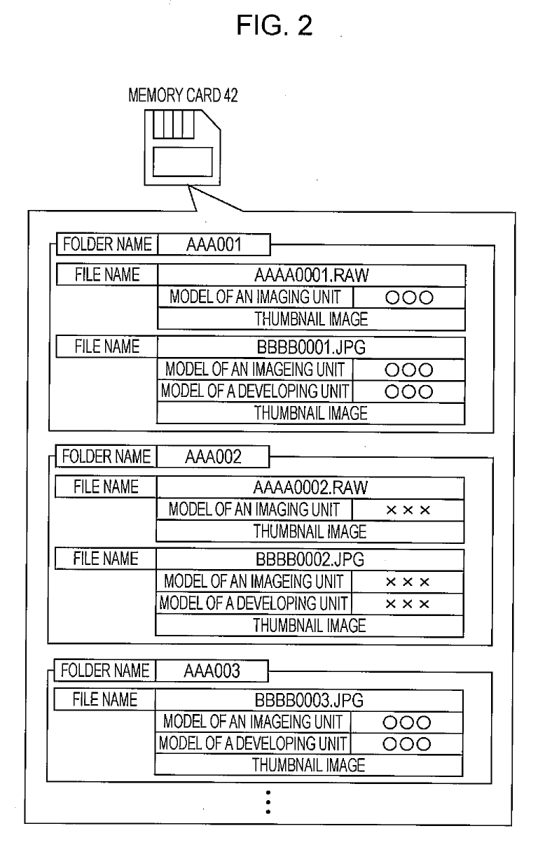

FIG. 2 shows an example of an image file stored in the memory card 42. As shown in FIG. 2, image files, such as an RAW file produced by taking a picture using a digital camera and a JPEG file are stored in the memory card 42. Each image file stored in the memory card 42 is given a file name with a sequential number consecutive to a name of a previous file produced in a previous step when a file produced by taking a picture using a digital camera is saved. When simultaneously recording the RAW data produced by taking a picture using a digital camera and the JPEG data produced on the basis of the RAW data, the same file name is given to the RAW data and the JPEG data, and the RAW data and the JPEG data are saved in the form of different files. With this embodiment, a RAW file and a JPEG file produced on the basis of the RAW file are saved in a single folder. In the case in which there is only the RAW file or the JPEG file, the only the RAW file or the JPEG file is saved in a single folder. Accordingly, whether there are the RAW file and the JPEG file simultaneously recorded in the memory card 42 can be check by using the folder name or the file names (number). In addition, the RAW data and the JPEG data produced on the basis of the corresponding RAW data are called a single group image data (image data in a single group, or image data in the same group). The RAW file contains information relating to a model of an imaging device (for example, maker or model name). Moreover, for some imaging devices, the RAW file also contains thumbnail images developed by the devices. The JPEG file contains information relating to a model of an imaging device, information relating a developing device, and a thumbnail image.

The manipulation panel 50 includes a displaying portion 52 and a button group 54. The displaying portion 52 is a liquid crystal display and displays various kinds of manipulation screens for allowing selection of menu items or settings, for example an image selection screen, a print setting screen, and a development parameter input screen. The button group 54 includes a power supply switch button (not shown) for turning on and off a power source, arrow keys 56 consisting of an up key 56a, a down key 56b, a left key 56c, and a right key 56d and performing selection of various items or settings, an OK button 57 for validating the selected setting, a return button for changing a current screen to a previous screen, a print setting button (not shown) for performing print settings, and a print button 58 for making an instruction of printing. The button group 54 is constructed such that instructions from a user can be delivered to the main controller 60 via an internal communication interface 69. As the print setting screen, even though not shown, includes setting items, such as paper kind (for example, photographic paper, plain paper, matte paper), paper size (for example, L-size, postcard size, A4-size), layout (for example, framed, unframed), print quality (for example, high speed, normal, clean), automatic image quality adjustment for automatically adjusting a tone of an image to an optimum tone (for example, not performing), brightness adjustment (for example, brighter, bright, normal, dark, darker), contrast (for example, normal, strong, weak), sharpness (for example, sharpness strong, sharpness weak, normal, soft focus weak, soft focus strong), and the setting items can be set by the arrow keys 56. The development parameter input screen, although not shown, further includes a setting item of an exposure value besides the above mentioned image quality adjustment items. The exposure value is set in the range from −2.0 to +2.0 using the arrow keys 56.

The main controller 60 is constituted as a microprocessor having a central processing unit (CPU) 62 as a core unit and includes a read only memory (ROM) 64 storing processing programs, various kinds of data, and tables therein, a random access memory (RAM) 66 temporarily storing scanned data and print data, a flash memory 68 which is electrically rewritable and can store data even when power is not supplied, and an internal communication interface 69 which enables communication with the manipulation panel 50. These parts are connected to each other via a bus 12 and thus signals can be exchanged between them. The main controller 60 receives various kinds of operation signals and various kinds of detection signals from the printer unit 20, the scanner unit 30, and the memory card controller 44, or receives manipulation signals generated according to manipulation of the button group 54 of the manipulation panel 50. The main controller 60 also sends instructions to the memory card controller 44 so that the RAW file and the JPEG file are read from the memory card 42 and the read RAW JPEG files are sent to the main controller 60. In addition, the main controller 60 sends an instruction to the printer unit 20 so that developed data (for example, image data compressed in JPEG format) is printed. In still addition, the main controller 60 sends an instruction to the scanner unit 30 so that the scanner unit 30 reads a document disposed on the glass substrate 36 as image data on the basis of a scanning instruction of the button group 54 of the manipulation panel 50, or sends a control instruction of the displaying portion 52 to the manipulation panel 50.

Next, operation of the multifunction printer 10 structured in the above-mentioned manner will be described. Particularly, operation for selecting the RAW file and the JPEG file in the same group stored in the memory card 42 and setting the number of print copies with respect to each of the data.

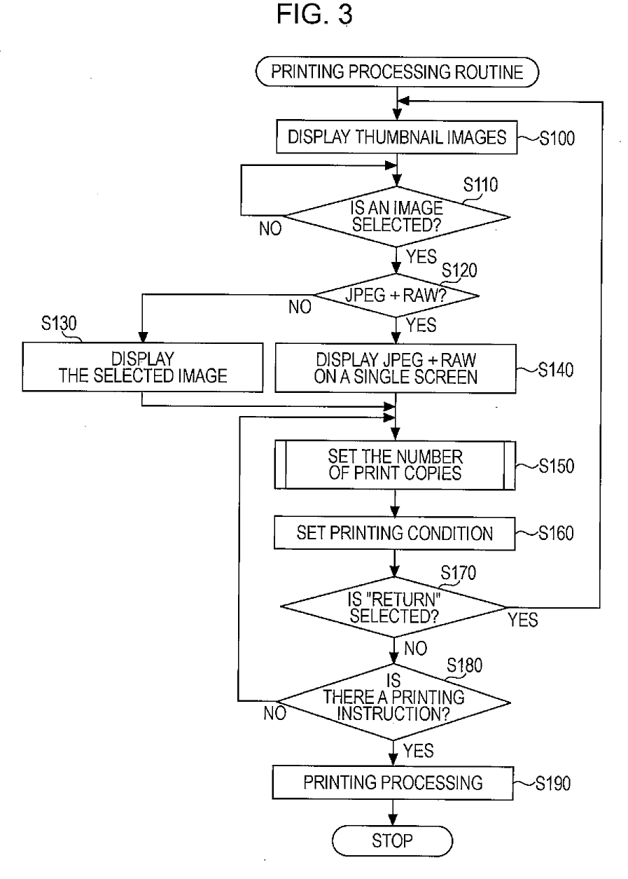

FIG. 3 shows a flow chart illustrating a printing processing routine executed by the CPU 62 of the multifunction printer 10. The routine is stored in the ROM 64 of the multifunction printer 10. The routine is executed when the memory card 42 is inserted into the memory card slot 40.

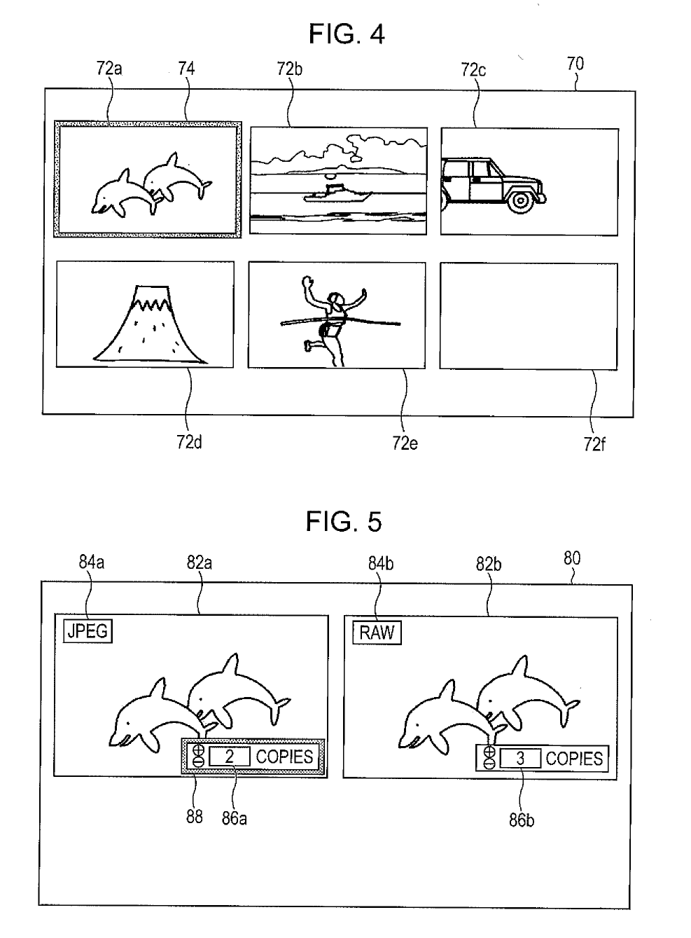

When the printing processing routine is executed, the CPU 62 of the multifunction printer 10 reads the thumbnail image of the image file stored in the memory card 42 first, displays the read thumbnail image on the image selections screen (step S100), and receives an input of image selection (step S110). FIG. 4 shows an example of the image selection screen 70. The image selections screen 70 can display 6 thumbnail images 72a through 72f in the form of two (2) row and three (3) columns. By manipulating the left and right keys 56c and 56d of the arrow keys 56, a cursor 74 is moved. When the cursor 74 is positioned at a left upper position of the figure, if the left key 56c is pressed down, six (6) images in a previous page are displayed. When the cursor 74 is positioned at a right lower position of the figure, if the right key 56d is pressed down, six images in a next page are displayed. The JPEG file and the RAW file in the same group are images that the each of thumbnail images stored in the JPEG files are displayed. When the thumbnail image of the RAW file is displayed, if the thumbnail image is contained in the RAW file, the development processing is performed with respect to the RAW file, and the thumbnail image is produced and displayed. When the RAW file has a format which cannot be developed in the multifunction printer 10, the thumbnail image is not displayed. The image selection can be accomplished by moving the cursor 74 so as to be located on a desired image of the thumbnail images 72a through 72f displayed on the image selection screen 70 by manipulating the left and right keys 56c and 56d, and then pressing the OK button 57.

If the image is selected in this manner, it is checked whether the selected image has the JPEG file and the RAW file in the same group (step S120). When the selected image does not have the JPEG file and the RAW file in the same group, since the selected image is either one of the JPEG file and the RAW file, the image data of the selected image is displayed on the selected image displaying screen (step S130). Conversely, when the selected image has the JPEG file and the RAW file in the same group, two image data are displayed on the selected image displaying screen (step S140). FIG. 5 shows an example a screen that two image data of the JPEG file and the RAW file in the same group are displayed on the selected image displaying screen 80. As shown in FIG. 5, in the selected image displaying screen 80, an image 82a of the JPEG file and an image 82b of the RAW file are arranged neighboring each other in a row, data format display frames 84a and 84b, which show data formats “JPEG” and “RAW” of the images 82a and 82b, are displayed at left upper sides of the corresponding images 82a and 82b, respectively, and print copy number display frames 86a and 86b, which show the number of print copies, are arranged at right lower sides of the corresponding images 82 and 82b.

After the selected image is displayed in this manner, print copy number setting processing for setting the number of print copies is executed (step S150), and if it is necessary, print setting processing for performing print setting such as paper kind, paper size, layout, and print quality is executed (step S160). The print copy number setting processing will be described later. The print setting processing is performed in a manner such that the print setting screen is displayed when the print setting button (not shown) is pressed, and various kinds of setting items, such as paper kind, paper size, layout, and print quality are selected by the use of the arrow keys 56. Then, when the return button (not shown) is pressed (step S170), the processing step is returned to step S100 and thus the thumbnail images are displayed on the image selection screen. Then, steps subsequent to step S100 are executed so that a different image can be selected. Conversely, when the return button is not pressed, the processing step is returned to step S150 until the print button 58 is pressed, steps S150 through S180 are repeatedly performed. When the print button 58 is pressed (step S180), a print control command is outputted to the printer ASIC 22 (step S190) so that printing with the number of copies set to each of the selected images is performed, and the main routine ends.

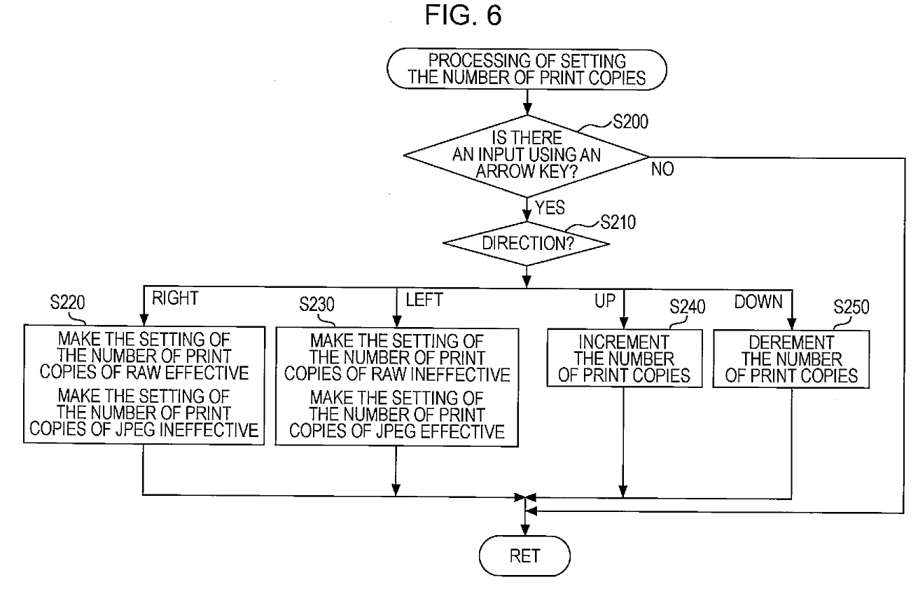

Next, the print copy number setting processing will be described. FIG. 6 is a flowchart illustrating an example of the print copy number setting processing performed by the controller 60. The value “1” is set as a default value of the number of print copies of the selected image. In the print copy number setting processing of FIG. 6, an input using the arrow keys 56 is received (step S200). In the case in which there is no input through the arrow keys 56, the main processing ends. However, there is an input through the arrow keys 56, it is checked which direction is inputted (step S210). That is, which key of the up key 56a, the down key 56b, the left key 56c, and the right key 56d is pressed. In the case in which the right direction is inputted through the right key 56d, the setting of the number of print copies of the image data of the RAW file is validated, the setting of the number of print copies of the image data of the JPEG file is invalidated (step S220), and the main processing ends. In the case in which the left direction is inputted through the left key 56c, the setting of the number of print copies of the image data of the RAW file is invalidated, the setting of the number of print copies of the image data of the JPEG file is validated (step S230), and the main processing ends. In the case in which the upper direction is inputted through the up key 56a, the number of the print copies in the print copy number setting frame, which is validated, is incremented by one. In this case, the maximum of the number of the print copies is a predetermined integer (for example, 10 or 20) (step S240), and then the main processing ends. In the case in which the lower direction is inputted through the down key 56b, the number of print copies in the print copy number setting frame is decremented by one with the minimum of zero (step S250), and then the main processing ends. On the other hand, in the case in which the group does not include a plurality of image files, that is, in the case in which only either one of the JPEG file and the RAW file exists, if the file is the JPEG file, processing of the step S220 is invalidated. Conversely, when the file is the RAW file, processing of the step S230 is invalidated. Further, as shown in FIG. 5, there is the possibility that the number of print copies of the image 82a of the JPEG file is set to 2, and the number of print copies of the image 82b of the RAW file is set to 3. In this case, the up key 56a is pressed one time in the state in which the cursor 88 is moved to be in the print copy number display frame 86a using the left key 56c, and the up key 56a is pressed two times in the state in which the cursor 88 is moved to be in the print copy number setting frame 86b by the use of the right key 56d. In this manner, it is possible to separately set the number of print copies of the image data of the JPEG file and the number of print copies of the image data of the RAW file in the same group only by the use of arrow keys 56. When the left key 56c is pressed in the state in which the setting of the number of print copies of the image data of the JPEG file is validated, or when the right key 56d is pressed in the state in which the setting of the number of print copies of the image data of the RAW file is validated, the print copy number setting processing ends and the processing is returned to step S100 of the printing processing routine of FIG. 3.

Here, correspondence relationship between elements of the embodiment and elements of the invention will be described. The left and right keys 56c and 56d of the arrow keys 56 of the embodiment correspond to a first key and the up key 56a and the down key 56b of the arrow keys 56 correspond to a second key of the invention. The controller 60 which performs step S150 of the printing processing routine of FIG. 3 and the print copy number setting processing of FIG. 6 corresponds to a processing parameter setting unit. The controller 60 which performs step S190 of the printing processing routine of FIG. 3 corresponds to a processing unit. The controller 60 which performs steps S120 through S140 of the printing processing routine of FIG. 3 corresponds to a display control unit. With this embodiment, a control method of an image processing device of the invention is apparently understood by describing operation of the multifunction printer 10.

According to the multifunction printer 10 of the above-mentioned embodiment, when one image group having the JPEG file and the RAW file in the same group is selected, it is possible to perform switching between validation and invalidation of the print copy number setting of the RAW file and the print copy number setting of the JPEG file in the same group by using the left key 56c and the right key 56d of the arrow keys 56, and to set the number of print copies of the print copy number setting (print copy number display frame) which is validly set by the use of the up key 56a and the down key 56b. Thus, since the image file selected when the print button 58 is pressed is printed by the amount of only the set print copy number, it is possible to separately set the print copy number of the JPEG file of the image data and the print copy number of the RAW file of the image data in the same group by simple manipulation using the arrow keys 56. Moreover, inputs of the arrow keys 56 including the left, right, up, and down keys are received in the state in which the image 82a of the JPEG file and the image 82b of the RAW file are arranged neighboring to each other in a row on the selected image display screen 80 and the print copy number display frames 86a and 86b are arranged in overlapping manner with the images 82a and 82b, respectively, it is possible to set the number of print copies by more perceptive manipulation.

With this embodiment, at step S110 of the printing processing routine of FIG. 3, the desired image is selected in a manner such that the cursor 74 is moved to be placed on one thumbnail image of thumbnail images 72a to 72f displayed on the image selection screen 70 by the use of left and right keys 56c and 56d and then the OK button 57 is pressed. However, a method of determining the image selection is not limited to such a method, i.e. a method of pressing the OK button 57, but the determination of the image selection may be made by the use of either the up key 56a or the down key 56b. The image selection may be accomplished in a manner such that the cursor 74 is moved to be placed on the desired image of the thumbnail images 72a through 72f displayed on the image selection screen 70 by the use of the up key 56a and the down key 56b instead of the left key 56c and the right key 56d, and then the OK button 57 is pressed. Alternatively, in this case, either the left key 56c or the right key 56d may be used instead of the OK button 57 for the determination of the image selection.

With this embodiment, validation and invalidation of the print copy number setting of the JPEG file and the print copy number setting of the RAW file are switched by the use of the left and right keys 56c and 56d of the arrow keys 56, and the print copy number of the print copy number setting, which is validly set, is set by the use of the up and down keys 56a and 56b of the arrow keys 56. However, alternatively, switching between validation and invalidation of the print copy number of the JPEG file and the print copy number of the RAW file may be performed by the use of the up and down keys 56a and 56b of the arrow keys 56, and the print copy number of the print copy number setting, which is validly set, may be set by the use of the left and right keys 56c and 56d. Alternatively, a single key may be used instead of paired keys: the pair of the up and down keys 56a and 56b, and the pair of the left and right keys 56c and 56d. In this method, every when the single is pressed, validation and invalidation of the print copy number setting of the JPEG file and the print copy number setting of the RAW file may be switched to one another.

With this embodiment, two files of the JPEG file and the RAW file in the same group are displayed on the same screen. However, alternatively, either one of the JPEG file and the RAW file may be displayed.

With this embodiment, print copy number settings of two image data of the JPEG file and the RAW file in the same group are separately performed by the use of the arrow keys 56. However, the parameter is not limited to the print copy number. The arrow keys 56 may be used for setting other print setting parameters, such as kinds of print paper, print paper size, and so on.

With this embodiment, the invention is described with the multifunction printer 10 as an example. However, the invention is not limited to the multifunction printer 10 but may be applied to any device as long as the device is structured in a manner such that processing parameters of a plurality of image files in the same group are separately set for each of the image file. Examples of the device include a picture viewer for replaying images, a digital camera, and a cellular phone with a camera. Further, the RAW file and the JPEG file produced on the basis of the RAW file are exemplified as the plurality of image files in the same group, but examples of the image files in the same group may include other formats, such as BMP file, TIFF file, and so on.

Although the invention is described with the above-mentioned embodiments, the invention is not limited to the above-described embodiments and it is natural that the invention be embodied in different forms within the technical scope of the invention.

The entire disclosure of Japanese Patent Application No. 2007-212647, filed Aug. 17, 2007 is incorporated by reference herein.

What is claimed is:

1. An image processing device processing an image, comprising:
a first key;
a second key;
a parameter setting unit which selects a processing object image on the basis of manipulation of the first key from a plurality of images of image data recorded in different formats and belonging to a single group and which sets processing parameters on the basis of manipulation of the second key for the selected processing object image; and
a processing unit which processes the plurality of images of the image data according to the processing parameters set with respect to each of the plurality of images of the image data.

2. The image processing device according to claim 1, wherein the image data belonging to the same group is RAW data and JPEG data produced on the basis of the RAW data.

3. The image processing device according to claim 1, wherein the image processing device is connected to a printing device, the second key includes two keys in one pair, the parameter setting unit is a unit for setting the number of print copies by increment or decrement as the set parameters on the basis of manipulation of the second key, and the processing unit is a unit for printing the plurality of images of the image data by the printing device according to the number of print copies set with respect to each of the plurality of images of the image data.

4. The image processing device according to claim 1, further comprising a display control unit which displays the plurality of images of the image data belonging to the same group on a single screen and displays a manipulation screen for manipulation of the first and second keys.

5. The image processing device according to claim 4, wherein the parameter setting unit performs a pre-step in which one group containing the processing objet image is selected from a plurality of groups, and the display control unit displays different screens in the pre-step and a step in which the processing object image is selected from the plurality of images of the image data belonging to the selected group, respectively.

6. The image processing device according to claim 1, further comprising four-directional keys including up, down, left, and right keys, respectively, wherein the first key includes either the up and down keys or the left and right keys, and the second key includes either the up and down keys or the left and right keys.

7. The image processing device according to claim 1, wherein the parameter setting unit is a unit for performing a pre-step in which one group containing the processing object image is selected form a plurality of groups on the basis of manipulation of the first key or the second key.

8. The image processing device according to claim 1, wherein the manipulations of the first key and the second key can be performed without interruption by manipulation of any other keys.
